(19) United States
(12) Patent Application Publication
(10) Pub. No.: US 2013/0222389 A1
(43) Pub. Date: Aug. 29, 2013

(54) INFORMATION PROCESSING DEVICE

(71) Applicant: Tsunehisa Kawamata, Tokyo (JP)

(72) Inventor: Tsunehisa Kawamata, Tokyo (JP)

(73) Assignee: NEC Corporation, Minato-ku, Tokyo (JP)

(21) Appl. No.: 13/823,682

(22) PCT Filed: Nov. 7, 2011
(86) PCT No.: PCT/JP2011/006188

§ 371 Date: May 9, 2013

(30) Foreign Application Priority Data
Nov. 9, 2010 (JP) 2010-250630

(51) Int. Cl. G06T 11/20

(52) U.S. Cl. CPC G06T 11/206
USPC 345/440

(57) ABSTRACT

An information processing device includes: a data schema storing means for storing data schemas representing data structures of graph data generated by the respective analysis engines; and an analysis data integrating means for integrating the graph data generated by the respective analysis engines. In each of the data schemas, path information for referring to the respective nodes in the graph data and node identification information for identifying the respective nodes are associated with each other. The analysis data integrating means is configured to receive the graph data that are analysis results from the respective analysis engines, and couple and integrate the graph data at the nodes whose node identification information are identical to each other based on the data schemas corresponding to the respective analysis engines.

### TECHNICAL FIELD

The present invention relates to an information processing device, more specifically, relates to an information processing device which integrates the results of analysis by a plurality of analysis engines and accumulates into a database.

### BACKGROUND ART

In recent years, as an information processing technique has developed, analysis engines which analyze various types of data have been developed. There are various types of analysis engines, for example, generating location information tracing the flow of a person from moving image data, specifying a person from still image data, generating text data from speech data, and so on.

The result of analysis by the analysis engine described above is used for search for analysis target data as disclosed in Patent Document 1. To be specific, in Patent Document 1, firstly, an image acquired by a camera is analyzed as analysis target data, a feature value as the result of the analysis is outputted, event data compliant with a search rule is generated based on the feature value and accumulated into an event database. Then, by searching for event data satisfying an inputted search condition, it is possible to refer to analysis target data satisfying the search condition.

Further, in Patent Document 1, when a search rule is added, new event data compliant with the added search rule is generated, and it becomes possible to search for the event data.

[Patent Document]

Patent Document 1: Japanese Unexamined Patent Application Publication No. 2007-134934

However, the technique disclosed by Patent Document 1 described above has a problem that, although flexibility of a search condition is secured, a searched range is limited to a range of events that can be analyzed by an image analyzing unit disclosed in FIG. 1 and so on of Patent Document 1. Because various methods for analysis by the image analyzing unit exist depending on a monitoring target, a monitoring range, a monitoring condition, and so on, the image analyzing unit needs to use the analysis methods in combination. In this case, the image analyzing unit does not use fixed methods but uses a plurality of methods in combination, and requires flexibility of event data so as to be capable of handling analysis results outputted by the analysis methods.

In the above case, because analysis results are outputted with respect to a single target as a result of a plurality of analysis processes, respectively, it is desirable to handle the analysis results as graph structures each having a data structure in which a plurality of nodes are connected. In this case, because a search process is executed on a plurality of graph data, integration of the plurality of graph data is required. However, a technique for integrating a plurality of graph data is not disclosed.

### SUMMARY

Accordingly, an object of the present invention is to provide an information processing device which is capable of solving the abovementioned problem, that is, capable of integrating analysis results generated by a plurality of engines.

In order to achieve the object, an information processing device according to an exemplary embodiment of the present invention includes:

a data schema storing means for storing data schemas which are set for respective analysis engines and represent data structures of graph data which are analysis results generated by the respective analysis engines and each include a plurality of connected nodes; and
an analysis data integrating means for integrating the graph data that are the analysis results generated by the respective analysis engines, wherein:

in each of the data schemas stored by the data schema storing means, path information for referring to the respective nodes in the graph data and node identification information for identifying the respective nodes referred to by the respective path information are associated with each other; and

the analysis data integrating means is configured to receive the graph data that are the analysis results from the respective analysis engines, and couple and integrate the graph data at the nodes whose node identification information are identical to each other based on the data schemas corresponding to the respective analysis engines.

Further, a computer program according to another exemplary embodiment of the present invention is a computer program including instructions for causing an information processing device including a data schema storing means for storing data schemas which are set for respective analysis engines and represent data structures of graph data which are analysis results generated by the respective analysis engines and each include a plurality of connected nodes, to realize an analysis data integrating means for integrating the graph data that are the analysis results generated by the respective analysis engines, wherein:

in each of the data schemas stored by the data schema storing means, path information for referring to the respective nodes in the graph data and node identification information for identifying the respective nodes referred to by the respective path information are associated with each other; and

the analysis data integrating means is configured to receive the graph data that are the analysis results from the respective analysis engines, and couple and integrate the graph data at the nodes whose node identification information are identical to each other based on the data schemas corresponding to the respective analysis engines.

Further, an information processing method according to another exemplary embodiment of the present invention is an information processing method by an information processing device including a data schema storing means for storing data schemas which are set for respective analysis engines and represent data structures of graph data which are analysis results generated by the respective analysis engines and each include a plurality of connected nodes, wherein in each of the data schemas stored by the data schema storing means, path information for referring to the respective nodes in the graph data and node identification information for identifying the respective nodes referred to by the respective path information are associated with each other,

the information processing method including:

in integration of the graph data that are the analysis results generated by the respective analysis engines, receiving the graph data that are the analysis results from the respective analysis engines, and coupling and integrating the graph data at the nodes whose node identification information are identical to each other based on the data schemas corresponding to the respective analysis engines.

With the configurations and functions as described above, the present invention makes it possible to integrate analysis results generated by a plurality of analysis engines.

### BRIEF DESCRIPTION OF DRAWINGS

FIG. 1 is a block diagram showing a configuration of an information processing system in a first exemplary embodiment of the present invention;

FIG. 2 is a diagram showing an example of a data schema of graph data defined by an analysis engine disclosed in FIG. 1;

FIG. 3 is a diagram showing an example of graph data according to the data schema disclosed in FIG. 2;

FIGS. 4A and 4B are diagrams showing examples of a data schema defined by an analysis engine disclosed in FIG. 1 and graph data according to the data schema;

FIGS. 5A and 5B are diagrams showing examples of a data schema defined by an analysis engine disclosed in FIG. 1 and graph data according to the data schema;

FIG. 6 is a diagram showing an example of data stored in a data schema disclosed in FIG. 1;

FIG. 7 is a diagram showing an example of graph data according to the data schema disclosed in FIG. 6;

FIG. 8 is a diagram showing an example of data representing an analysis process procedure stored in an analysis process flow disclosed in FIG. 1;

FIG. 9 is a diagram showing an example of data stored in an event rule disclosed in FIG. 1;

FIG. 10 is a flowchart showing an operation by the information processing system disclosed in FIG. 1;

FIG. 11 is a flowchart showing an operation by the information processing system disclosed in FIG. 1;

FIG. 12 is a diagram showing an aspect of a graph data integration process by the information processing system disclosed in FIG. 1;

FIG. 13 is a diagram showing an aspect of a graph data integration process by the information processing system disclosed in FIG. 1;

FIG. 14 is a diagram showing an aspect of a graph data integration process by the information processing system disclosed in FIG. 1;

FIG. 15 is a diagram showing an aspect of a graph data integration process by the information processing system disclosed in FIG. 1; and

FIG. 16 is a block diagram showing a configuration of an information processing device in Supplementary Note 1 of the present invention.

### EXEMPLARY EMBODIMENTS

<First Exemplary Embodiment>

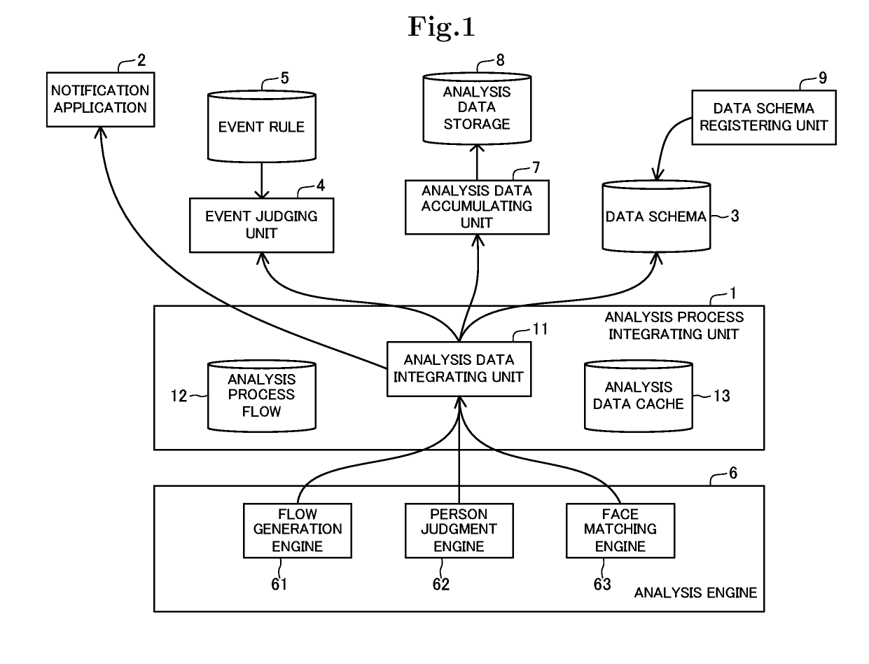

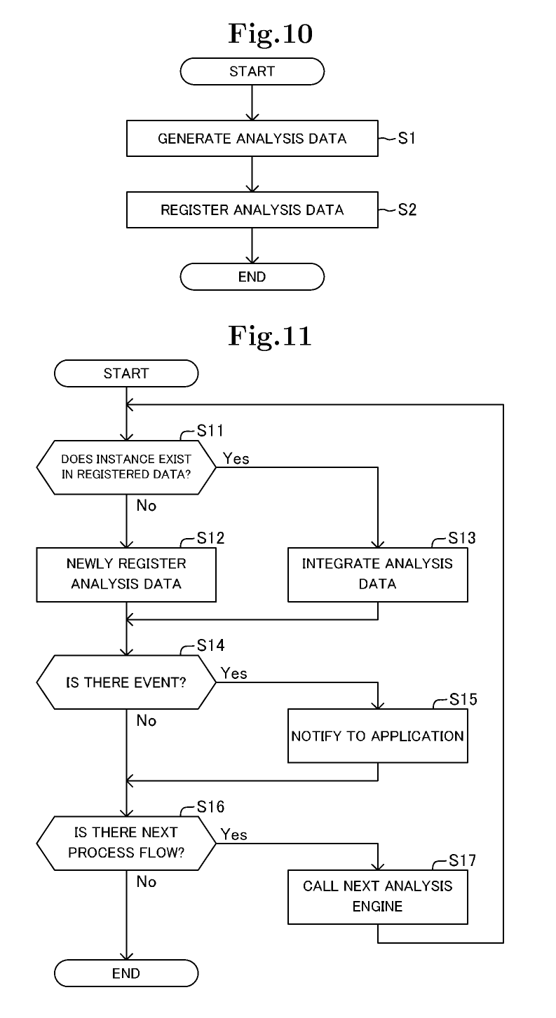

A first exemplary embodiment of the present invention will be described with reference to FIGS. 1 to 15. FIGS. 1 to 9 are diagrams for describing a configuration of the present invention, and FIGS. 10 to 15 are diagrams for describing an operation.

An information processing system according to the present invention is a system which is configured by one or a plurality of information processing devices, is equipped with a plurality of analysis engines 61 to 63 as shown in FIG. 1 and integrates graph data that are the results of analysis by the respective analysis engines.

To be specific, as shown in FIG. 1, the information processing system includes an analysis process integrating unit 1, a data schema 3, a data schema registering unit 9, an analysis data accumulating unit 7, an analysis data storage 8, an event judging unit 4, an event rule 5, a notification application 2, and an analysis engine 6. Moreover, the analysis process integrating unit 1 includes an analysis data integrating unit 11, an analysis process flow 12, and an analysis data cache 13.

The analysis data integrating unit 11, the data schema registering unit 9, the analysis data accumulating unit 7, the event judging unit 4, the notification application 2 and the analysis engine 6 are realized by installation of programs into an arithmetic device incorporated in the information processing system. Moreover, the analysis process flow 12, the analysis data cache 13, the data schema 3, the analysis data storage 9 and the event rule 5 are formed in a storage device incorporated in the information processing system. Below, the respective components will be described in detail.

The analysis engine 6 analyzes media data such as image data and speech data, and outputs analysis data that is an analysis result to the analysis data integrating unit 11. In this exemplary embodiment, as the analysis engine 6, a flow generation engine 61, a person judgment engine 62 and a face matching engine 63 are included. These analysis engines 61 to 63 analyze the same media data and output analysis data, respectively, and the outputted analysis data are integrated by the analysis data integrating unit 11 as described later. The analysis engine 6 may be an engine executing any analysis process.

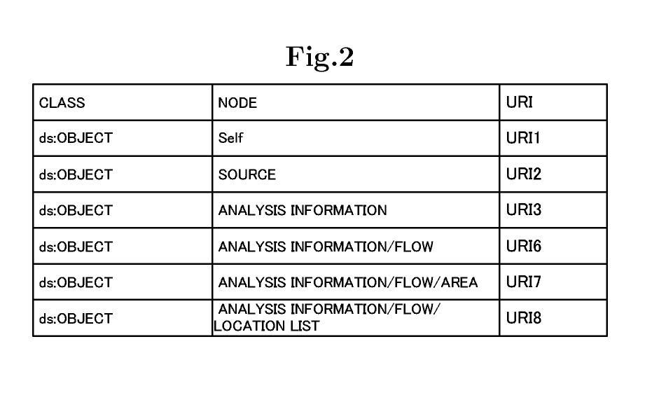

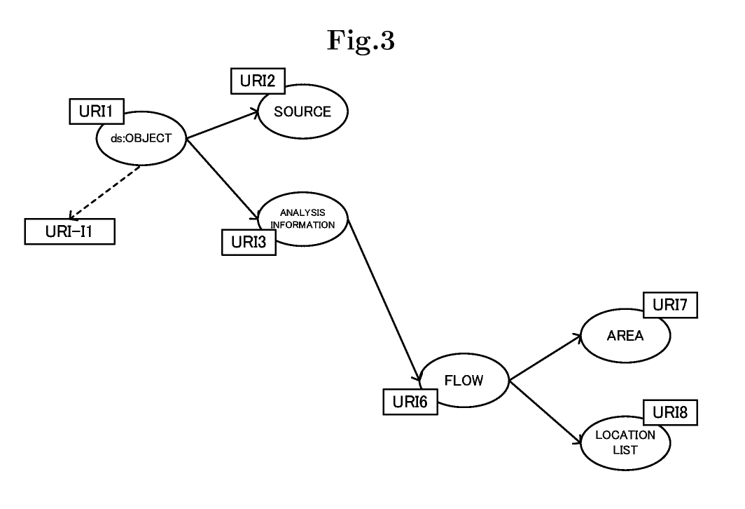

The flow generation engine 61 executes a process of generating location information tracing the flow of a person, from moving image data that becomes an analysis target acquired by a camera. Analysis data that is the result of analysis by the flow generation engine 61 has a data structure of graph data in which a plurality of nodes are connected. A data schema that defines graph data outputted by the flow generation engine 61 is shown in FIG. 2, and graph data represented by the data schema is shown in FIG. 3.

The data schema defined by the flow generation engine 61 shown in FIG. 2 stores “class” that identifies the data structure of graph data of the analysis engine, “node” that is path information referring to each of the nodes within the graph data of the analysis data, and “URI” that is identification information identifying each of the nodes.

To be specific, in FIG. 2, information of the graph data of the flow generation engine 61 is stored, and therefore, information “ds: object” is stored in all of the fields of “class.”

Moreover, path information referring to each of the nodes is stored in the field of “node.” For example, because a node “object” is located at the top in the graph data, information “self” is stored as path information therefor. Moreover, because a node “analysis information” is located below “object,” information “analysis information” is stored as path information therefor. Moreover, because a node “flow” is located in a hierarchy of “object”→“analysis information”→“flow” in the graph data, information “analysis information/flow” is stored as path information therefor. In a like manner, because a node “area” is located in a hierarchy of “object”→“analysis information”→“flow”→“area” in the graph data, information “analysis information/flow/area” is stored as path information therefor.

Further, in the field of “URI,” in association with each “node” described above, a unique “URI” (node identification information) identifying the node is stored. For example, “URI 1” is stored in association with the node “object” as a URI thereof, “URI 3” is stored in association with the node “analysis information” as a URI thereof, “URI 6” is stored in association with the node “flow” as a URI thereof, and “URI 7” is stored in association with the node “area” as a URI thereof.

Based on the data schema defined as described above, the flow generation engine 61 outputs the result of analysis of the moving image data of the analysis target, as the graph data shown in FIG. 3. At this moment, the flow generation engine 61 generates an instance of the class “ds: object,” and provides this instance with an “instance URI” (graph identification information) that is unique identification information. For example, as shown in FIG. 3, the flow generation engine 61 provides the generated instance with “URI-I1” as an instance URI, and inserts the graph data of the analysis result into this instance. Then, the flow generation engine 61 outputs the analysis result to the analysis data integrating unit 11.

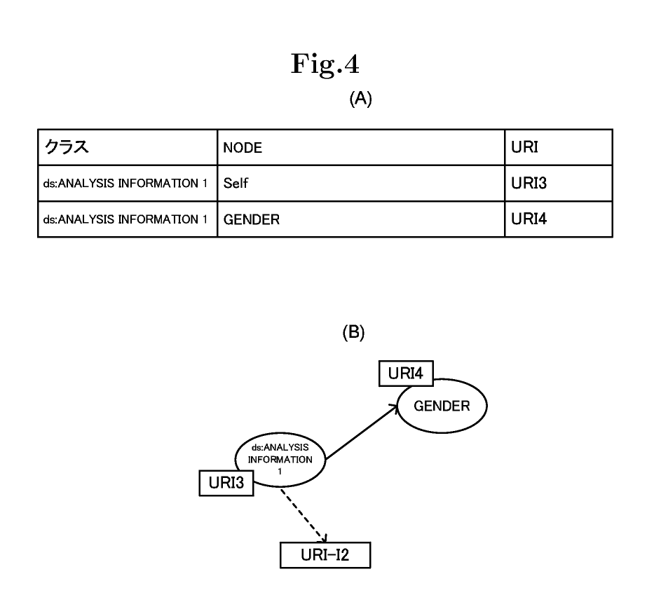

Further, the person judgment engine 62 executes a process of judging whether the object included in the moving image data transmitted from the flow generation engine 61 is a person or not. Analysis data that is the result of analysis by the person judgment engine 62 has a data structure of graph data in which a plurality of nodes are connected. A data schema that defines graph data outputted by the person judgment engine 62 is shown in FIG. 4A, and graph data represented by the data schema is shown in FIG. 4B.

The data schema defined by the person judgment engine 62 shown in FIG. 4A, in the same manner as described above, stores “class” that identifies the data structure of graph data of the analysis engine, “node” that is path information referring to each of the nodes within the graph data of the analysis engine, and “URI” that is identification information identifying each of the nodes.

To be specific, in FIG. 4A, information of the graph data of the person judgment engine 62 is stored, and therefore, information “ds: analysis information 1” is stored in all of the fields of “class.” Moreover, path information referring to each of the nodes is stored in the field of “node.” For example, because a node “analysis information 1” is located at the top in the graph data, information “self” is stored as path information therefor. Moreover, because a node “gender” is located below “analysis information 1,” information “gender” is stored as path information therefor.

Further, in the field of “URI,” in association with each “node” described above, a unique “URI” (node identification information) identifying the node is stored. Herein, it is assumed that the node “analysis information 1” is an identical node (a common term) to the node “analysis information” in the graph data generated by the flow generation engine 61 described above. In this case, as the URI of the node “analysis information 1” in the graph data generated by the person judgment engine 62, “URI 3” that is identical to the URI of the node “analysis information” in the graph data generated by the flow generation engine 61 is set. As a URI of the node “gender,” “URI 4” is set.

Based on the data schema defined as described above, the person judgment engine 62 outputs the result of analysis of the moving image data of the analysis target outputted from the flow generation engine 61, as the graph data shown in FIG. 4B. At this moment, the person judgment engine 62 generates an instance of the class “ds: analysis information 1,” and provides this instance with an “instance URI” (graph identification information) that is unique identification information. For example, as shown in FIG. 4B, the person judgment engine 62 provides the generated instance with “URI-I2” as an instance URI, and inserts the graph data as the analysis result into this instance. Then, the person judgment engine 62 outputs the analysis result to the analysis data integrating unit 11.

When receiving the moving image data outputted by the flow generation engine 61, the person judgment engine 62 also receives “URI-I1” that is the instance URI identifying the instance of the graph data of the analysis result generated by the flow generation engine 61. Then, the person judgment engine 62 outputs this instance URI “URI-I1” to the analysis data integrating unit 11 as an instance URI of integration source data, together with the analysis data of the person judgment engine 62.

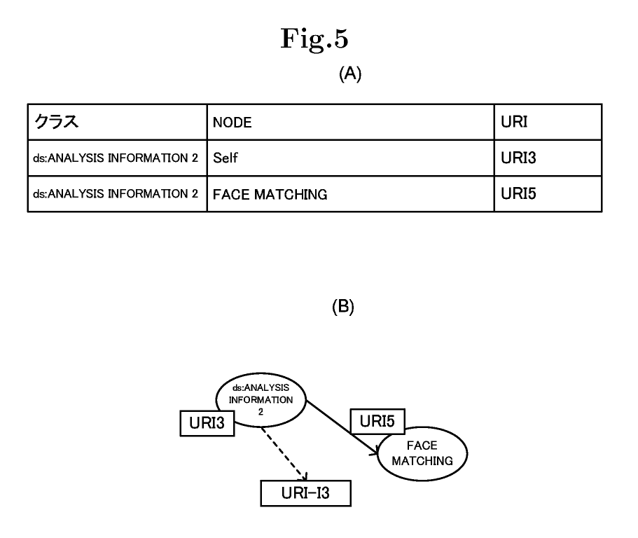

Further, the face matching engine 63 executes a process of judging whether the person included in the moving image data transmitted from the flow generation engine 61 agrees with data within a face matching database registered in advance. Analysis data that is the result of analysis by the face matching engine 63 has a data structure of graph data in which a plurality of nodes are connected. A data schema that defines graph data outputted by the face matching engine 63 is shown in FIG. 5A, and graph data represented by the data schema is shown in FIG. 5B.

The data schema defined by the face matching engine 63 shown in FIG. 5A, in the same manner as described above, stores “class” that identifies the data structure of the graph data of the analysis engine, “node” that is path information referring to each of the nodes within the graph data of the analysis data, and “URI” that is identification information identifying each of the nodes.

To be specific, in FIG. 5A, information of the graph data of the face matching engine 63 is stored, and therefore, information “ds: analysis information 2” is stored in all of the fields of “class.” Moreover, path information referring to each of the nodes is stored in the field of “node.” For example, because a node “analysis information 2” is located at the top in the graph data, information “self” is stored as path information therefor. Moreover, because a node “face matching” is located below “analysis information 2,” information “face matching” is stored as path information therefor.

Further, in the field of “URI,” in association with each “node” described above, a unique “URI” (node identification information) identifying the node is stored. Herein, it is assumed that the node “analysis information 2” is previously set as an identical node (a common term) to the node “analysis information” in the graph data generated by the flow generation engine 61 described above. In this case, as the URI of the node “analysis information 2” in the graph data generated by the face matching engine 63, “URI 3” that is identical to the URI of the node “analysis information” in the graph data generated by the flow generation engine 61 is set. As a URI of the node “face matching,” “URI 5” is set.

Based on the data schema defined as described above, the face matching engine 63 outputs the result of analysis of the moving image data that is the analysis target outputted from the flow generation engine 61, as the graph data shown in FIG. 5B. At this moment, the face matching engine 63 generates an instance of the class “ds: analysis information 2,” and provides this instance with an “instance URI” (graph identification information) that is unique identification information. For example, as shown in FIG. 5B, the face matching engine 63 provides the generated instance with “URI-I3” as an instance URI, and inserts the graph data of the analysis result into this instance. The face matching engine 63 then outputs the analysis result to the analysis data integrating unit 11.

When receiving the moving image data outputted by the flow generation engine 61, the face matching engine 63 also receives “URI-I1” that is the instance URI identifying the instance of the graph data of the analysis result generated by the flow generation engine 61. The face matching engine 63 then outputs this instance URI “URI-I1” to the analysis data integrating unit 11 as the instance URI of the integration source data, together with the analysis data of the face matching engine 63.

Because the analysis processes by the analysis engines 61 to 63 are already-known analysis processes, a detailed description thereof will be omitted.

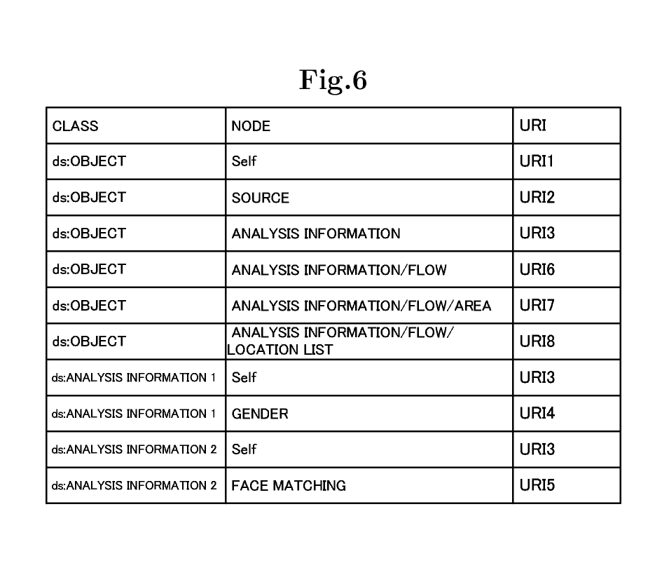

Then, the analysis data integrating unit 11 (an analysis data integrating means) integrates the graph data that are the results of analysis by the respective analysis engines 61 to 63 into one or a plurality of graph data. At this moment, the analysis data integrating unit 11 executes an integration process with reference to the data schema 3 (a data schema storing means) representing the data structure of graph data integrating the respective graph data. An example of data registered in the data schema 3 is shown in FIG. 6. [0038]

The data schema 3 shown in FIG. 6 has a function of automatically or manually registering the data schema shown in FIG. 6 from the data schemas in the respective analysis engines 61 to 63 previously registered by the data schema registering unit 9. To be specific, the data schema 3 shown in FIG. 6 is configured by combining the data schema of the flow analysis engine shown in FIG. 2 described above, the data schema of the person judgment engine 62 shown in FIG. 4A, and the data schema of the face matching engine 63 shown in FIG. 5A. Therefore, the data schema 3 of FIG. 6 stores “class” that identifies the data structure of graph data of each of the analysis engines, “node” that is path information referring to each of the nodes within the graph data of the analysis engines, and “URI” that is identification information identifying each of the nodes. In particular, in the fields of “URI,” the same “URI 3” is set for the same nodes “analysis information,” “analysis information 1” and the analysis information 2 as described above.

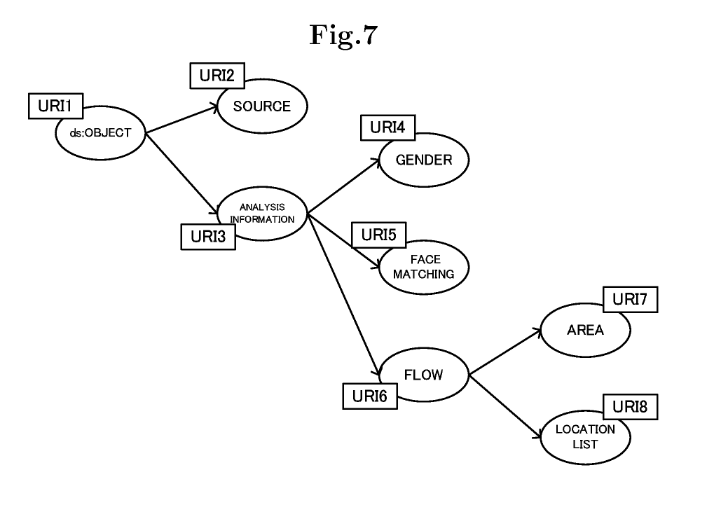

With reference to the data schema 3 previously defined as shown in FIG. 6, the analysis data integrating unit 11 executes a process of integrating the graph data received from the respective analysis engines 61 to 63 by connecting at nodes whose “URI” are identical to each other. To be specific, as shown in FIG. 7, the analysis data integrating unit 11 integrates by connecting nodes located, respectively, below the node “analysis information 1” and the node “analysis information 2” whose URI are both “URI 3” among the nodes of the graph data shown in FIG. 4B generated by the person judgment engine 62 and the graph data shown in FIG. 5B generated by the face matching engine 63, to below the node “analysis information” whose URI is “URI 3” among the nodes of the graph data shown in FIG. 3 generated by the flow generation engine 61.

That is to say, regarding the example of this exemplary embodiment shown by FIGS. 6 and 7, the URIs of the nodes (analysis information 1 and analysis information 2) located in the highest hierarchy, respectively, of the graph data generated by the person judgment engine 62 and the face matching engine 63, and the URI of the node (analysis information) located in a predetermined hierarchy of the graph data generated by the flow generation engine 61 are set to be identical to each other. Based on this, the analysis data integrating unit 11 integrates the graph data by connecting nodes (gender, face matching) located in hierarchies lower than the nodes (analysis information 1, analysis information 2) located in the highest hierarchies of the respective graph data generated by the person judgment engine 62 and the face matching engine 63, to below the node (analysis information) located in the predetermined hierarchy of the graph data generated by the flow generation engine 61.

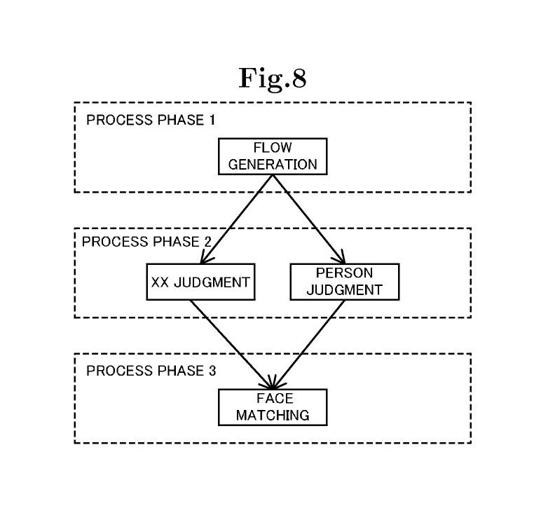

Further, the analysis data integrating unit 11 calls and causes the analysis engines 61 to 63 to execute processes in accordance with execution sequence data stored in the analysis process flow 12 (an execution sequence storing means), and receives and integrates graph data of the results of the respective analyses. An example of the execution sequence data stored in the analysis process flow 12 is shown in FIG. 8. As shown in FIG. 8, the execution sequence data is configured by three process phases 1, 2 and 3. In the “process phase 1,” “flow generation” is set and hence the flow generation engine 61 is called and caused to execute the process. In the “process phase 2,” “person judgment” and “XX judgment” are set and hence the person judgment engine 62 and a XX judgment engine which is not shown in the drawings are called and caused to execute the processes in parallel. In the “process phase 3,” “face matching” is set and hence the face matching engine 63 is called and caused to execute the process.

Further, the analysis data integrating unit 11 receives, as well as the graph data of the analysis results, the instance URIs of the graph data from the analysis engines caused to execute the processes in the respective process phases. Moreover, the analysis data integrating unit 11 receives the graph data and sequentially accumulates the graph data into the analysis data storage 8 via the analysis data accumulating unit 7 and, in a case that a received instance URI is not registered in the analysis data storage 8, newly stores graph data together with the instance URI into the analysis data storage 8.

Furthermore, when calling the respective analysis engines 61 to 63 in accordance with the abovementioned execution sequence data, the analysis data integrating unit 11 gives an instance URI received from a previously called analysis engine to an analysis engine to be called and caused to execute the process next as an integration source instance URI. Because the integration source instance URI is outputted together with an analysis result from the analysis engine to be caused to execute the process next, the analysis data integrating unit 11 receives both of them. Then, the analysis data integrating unit 11 executes a process of integrating graph data of analysis data outputted by the analysis engine caused to execute the process next with graph data of the analysis engine that has previously been caused to execute the process and has outputted an identical instance URI to the integration source URI received from the analysis engine caused to execute the process next.

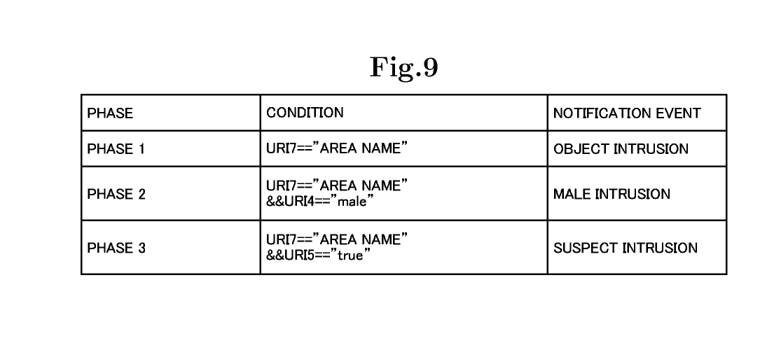

Further, in the event rule 5 (an execution rule storing means) included by the information processing system as shown in FIG. 1, “phase” in which graph data is registered by each of the analysis engines, “notification event” (execution process information) representing a process to be executed and “condition” (execution condition information) for executing the process are stored as shown in FIG. 9. The “notification event” is the content of a notification event for which a notification to the outside is outputted. In the “condition,” a state of registration of information into each of the nodes of graph data is set as a condition for executing the notification process.

For example, FIG. 9 shows a case that, when “area name” is registered into the node with “URI 7” in the “phase 1,” it is set to execute notification of “object intrusion.” Likewise, when “area name” is registered into the node with “URI 7” and information of “male” is registered into the node with “URI 4” in the “phase 2,” it is set to execute notification of “male intrusion.” Besides, when “area name” is registered into the node with “URI 7” and information of “true” is registered into the node with “URI 5” in the “phase 3,” it is set to execute notification of “suspect intrusion.”

The event judging unit 4 executes judgment whether to execute the “notification event” described above at a time when the analysis data integrating unit 11 accepts graph data from each of the analysis engines 61 to 63 and newly registers or integrates and registers the graph data into the analysis data storage 8, by judging whether the graph data satisfies the abovementioned “condition” or not. At this moment, in a case that the event judging unit 4 judges the abovementioned “condition” is satisfied, the notification application 2 (a process executing means) executes the process of “notification event.”

The abovementioned “notification event” is an example, and a process executed in a case that “condition” is satisfied may be any process. Moreover, the abovementioned “condition” is an example, and a case that certain information is registered into a designated node and a case that preset information is registered into a designated node have been described. However, any condition may be set. Furthermore, in the above description, the analysis data integrating unit 11 accepts graph data from each of the analysis engines 61 to 63, integrates the graph data every time the reception is executed, and executes a “notification process” satisfying the “condition” every time the integration is executed. However, timing of execution of a “notification event” and judgment whether the “condition” is satisfied may be executed at any timing, for example, may be executed at a time when the analysis data integrating unit 11 accepts graph data from each of the analysis engines 61 to 63.

Further, the processes executed by the event judging unit 4 and the notification application 2 are not limited to being executed on graph data obtained by integrating a plurality of graph data as described above, and can be applied to any graph data in which node identification information like “URI” described above is associated with each node.

[Operation]

Next, an operation of the information processing system will be described with reference to FIGS. 10 to 15. As shown in FIG. 10, the information processing system executes two major processes. One of them is a process of registering analysis data analyzed by the analysis engines 61 to 63 into the analysis process integrating unit 1 (refer to FIG. 10), and the other is a process of interpreting the analysis data registered into the analysis process integrating unit 1, integrating the analysis data, accumulating, and executing an event process (refer to FIG. 11).

The first process will be described with reference to FIG. 10. Upon executing an analysis process to generate analysis data (step S1), each of the analysis engines 61 to 63 registers the generated analysis data into the analysis data integrating unit 11 (step S2). At this moment, each of the analysis engines 61 to 63 generates an instance to insert graph data that is the generated analysis data, and provides the instance with an instance URI for identifying the instance. Then, each of the analysis engines 61 to 63 registers, together with the instance URI, the graph data inserted in the instance into the analysis data integrating unit 11.

The abovementioned steps S1 and S2 are executed for each of the analysis engines 61 to 63 in order in accordance with the execution sequence data stored in the analysis process flow 12 as described later. At this moment, an analysis engine caused to execute the process second or later accepts an instance URI for identifying an instance of graph data generated by an analysis engine previously caused to execute the process, as information for designating graph data that becomes an integration source. Then, the analysis engine caused to execute the process secondly or later registers, together with graph data of generated analysis data and an instance URI, the instance URI for designating the graph data generated by the analysis engine previously caused to execute the process into the analysis data integrating unit 11.

Next, an operation executed after the analysis data integrating unit 11 receives the analysis data from the analysis engines 61 to 63 will be described with reference to FIG. 11.

Firstly, upon receiving the analysis data from the analysis engines 61 to 63, the analysis data integrating unit 11 confirms whether the instance URI exists in the analysis data storage 8 via the analysis data accumulating unit 7 (step S11). In a case that the instance URI does not exist in the analysis data storage 8, the analysis data integrating unit 11 newly registers the graph data into the analysis data storage 8 (step S12). In a case that the instance URI exists in the analysis data storage 8, the analysis data integrating unit 11 acquires the existing graph data having been accumulated, and integrates the graph data newly registered from the analysis engine with the acquired graph data (step S13).

Next, the event judging unit 4 judges whether there is an applicable event based on the analysis data (step S14). When there is an applicable event (step S14: Yes), the event judging unit 4 notifies to the notification application 2 (step S15). When there is no applicable event (step S14: No), the event judging unit 4 does nothing.

Finally, in accordance with the analysis process flow 12, an analysis engine caused to execute a process next to the analysis engine whose analysis data has been registered is acquired (step S16). When there is a next analysis engine (step S16: Yes), the analysis data integrating unit 11 calls the next analysis engine (step S17). When there is no next analysis engine (step S16: No), the procedure ends.

A specific example of the operations shown in FIGS. 10 and 11 will be described with reference to FIGS. 10 to 11 and FIGS. 12 to 15. Firstly, in the “process phase 1,” the flow generation engine 61 analyzes moving image data that is an analysis target to generate analysis data (step S1), and registers the graph data and instance URI “URI-I1” shown in FIG. 3 into the analysis data integrating unit 11 (step S2).

The analysis data integrating unit 11 checks whether the received instance URI

“URI-I1” is registered in the analysis data storage 8 via the analysis data accumulating unit 7 (step S11). Herein, because “URI-I1” is not registered (step S11: No), the analysis data integrating unit 11 newly registers the graph data shown in FIG. 3 into the analysis data storage 8 (step S12).

Subsequently, the event judging unit 4 judges whether there is an applicable event based on the registered graph data (step S14). Herein, “area name” is registered in the node with “URI 7” as shown in FIG. 3, the “condition” set for the “phase 1” shown in FIG. 9 is satisfied, and the event judging unit 4 judges there is a notification event of “object intrusion” (step S14: Yes). Therefore, the event judging unit 4 notifies to the notification application 2 that there is a notification event of “object intrusion” (step S15), and the notification application 2 executes a notification event of “object intrusion.”

After that, the analysis data integrating unit 11 proceeds to the next process phase (step S16: Yes), and calls the analysis engine set in the process phase 2 (step S17). At this moment, the analysis data integrating unit 11 gives the instance URI “URI-I1” of the analysis data generated in the process phase 1 to the analysis engine set in the process phase 2, herein, to the person judgment engine 62.

Next, in the “process phase 2,” the person judgment engine 62 is called, and the person judgment engine 62 receives moving image data of an analysis target from the flow generation engine 61, and also receives the instance URI “URI-I1” of the analysis data generated by the flow generation engine 61 from the analysis data integrating unit 11. Then, the person judgment engine 62 analyzes the moving image data to generate analysis data (step S1), and registers the graph data and instance URI “URI-I2” shown in FIG. 4B and also “URI-I1” that is the instance URI of the analysis data generated by the flow generation engine 61 given at the time of calling and that is for designating integration source graph data, into the analysis data integrating unit 11 (step S2).

Then, the analysis data integrating unit 11 confirms whether the received instance URI “URI-I1” and “URI-I2” are registered in the analysis data storage 8 via the analysis data accumulating unit 7 (step S11). At this moment, because the instance URI “URI-I1” for designating the integration source is registered (step S11: Yes), the analysis data integrating unit 11 integrates by adding the graph data shown in FIG. 4B designated by “URI-I2” that is not registered to the graph data shown in FIG. 3 designated by “URI-I1” (step S13).

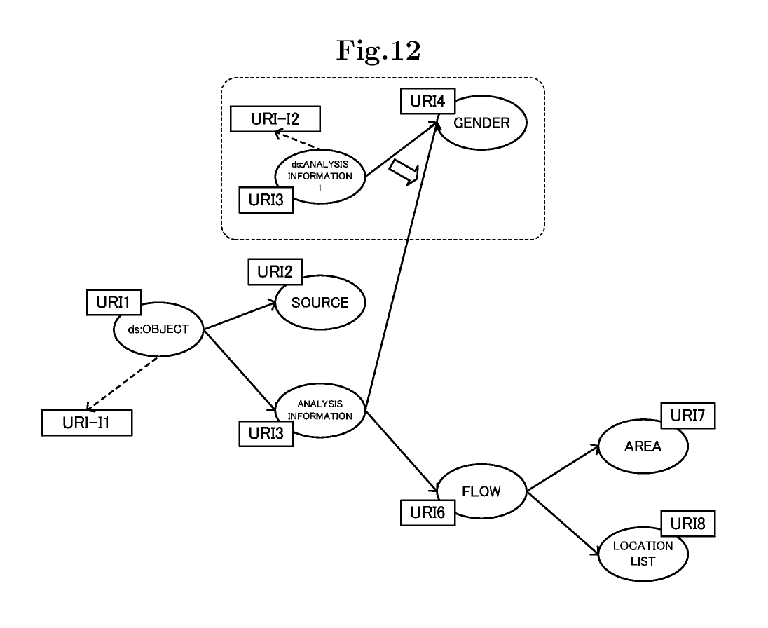

To be specific, the analysis data integrating unit 11 finds that the URI of a top node of the graph data with “URI-I2” to be added is “URI 3” as shown in FIG. 4B. Moreover, because the class of the integration source graph data designated by “URI-I1” is the class “ds: object,” the analysis data integrating unit 11 finds with reference to the data schema shown in FIG. 6 that a node with the same URI “URI 3” is the node “analysis information” of the class “ds: object.” Thus, as shown in FIG. 12, the analysis data integrating unit 11 replaces a link connected to the node “analysis information 1” of “URI-I2” with the node “analysis information” of “URI-I1” (refer to the inside of a dotted line frame and an arrow shown in FIG. 12).

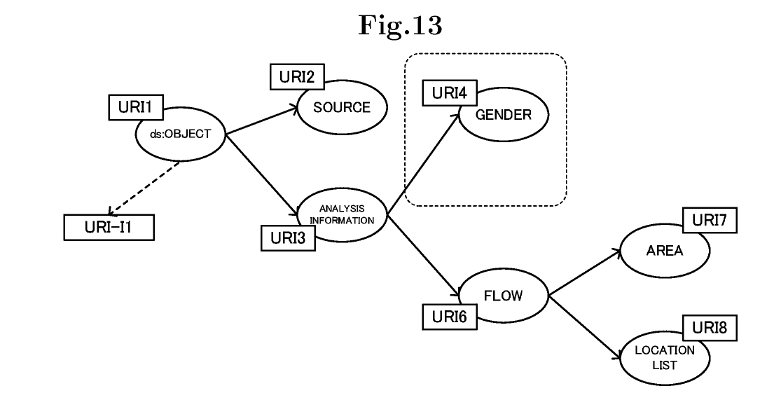

Then, as shown within a dotted line frame shown in FIG. 13, the analysis data integrating unit 11 integrates the graph data of “URI-I2” with the graph data of “URI-I1,” and registers into the analysis data storage 8 (step S13).

Subsequently, the event judging unit 4 judges whether there is an applicable event based on the registered graph data (step S14). At this moment, in a case that “area name” is registered in the node with “URI 7” and a value of “male” is registered in the node “gender” with “URI 4” as shown in FIG. 13, the “condition” set in the “process phase 2” shown in FIG. 9 is satisfied, so that the event judging unit 4 judges there is a notification event of “male intrusion” (step S14: Yes). Therefore, the event judging unit 4 notifies to the notification application 2 that there is a notification event of “male intrusion” (step S15), and the notification application 2 executes a notification event of “male intrusion.” Although there is another analysis engine caused to execute a process in parallel in the process phase 2, a description thereof will be omitted herein.

After that, the analysis data integrating unit 11 proceeds to the next process phase (step S16: Yes), and calls the analysis engine set in the process phase 3 (step S17). At this moment, the analysis data integrating unit 11 gives the instance URI “URI-I1” and the instance URI “URI-I2” of the analysis data generated in the abovementioned process phases 1 and 2, to the analysis engine set in the process phase 3, herein, to the face matching engine 63.

Next, in the “process phase 3,” the face matching engine 63 is called, and the face matching engine 63 receives the moving image data of the analysis target from the flow generation engine 61 or the person judgment engine 62. The face matching engine 63 also receives the instance URI “URI-I1” of the analysis data generated by the flow generation engine 61 and the instance URI “URI-I2” of the analysis data generated by the person judgment engine 62 from the analysis data integrating unit 11. Then, the face matching engine 63 analyzes the moving image data to generate analysis data (step S1), and registers graph data and instance URI “URI-I3” shown in FIG. 5B and also “URI-I1” that is the instance URI of the analysis data generated by the flow generation engine 61 given at the time of calling and that is for designating the integration source graph data, into the analysis data integrating unit 11 (step S2).

Then, the analysis integrating unit 11 confirms whether the instance URI “URI-I1,” instance URI “URI-I2” and instance URI “URI-I3” having been received are registered in the analysis data storage 8 via the analysis data accumulating unit 7 (step S11). Herein, because the instance URI “URI-I1” for designating the integration source and the instance URI “URI-I2” are registered (step S11: Yes), the analysis integrating unit 11 integrates by adding the graph data shown in FIG. 5B designated by “URI-I3” that is not registered to the graph data shown in FIG. 13 designated by “URI-I1” (step S13).

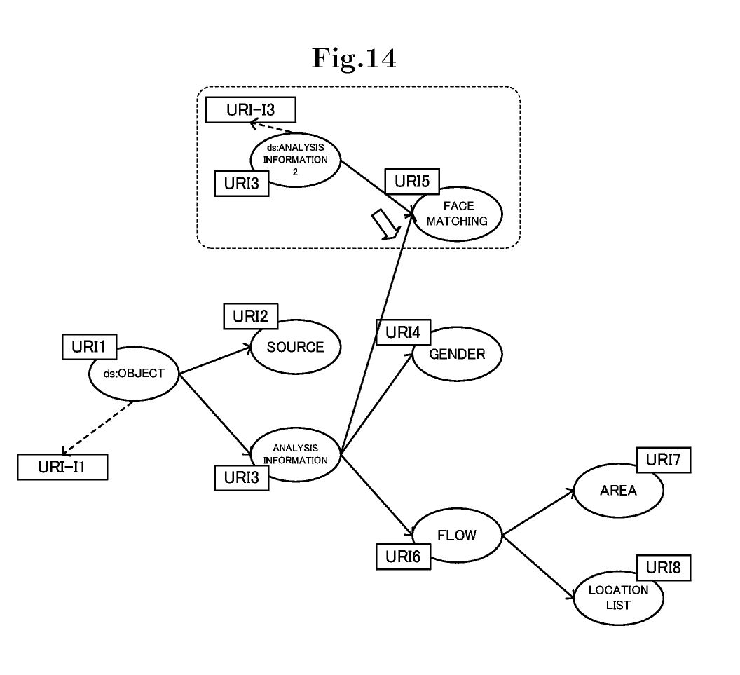

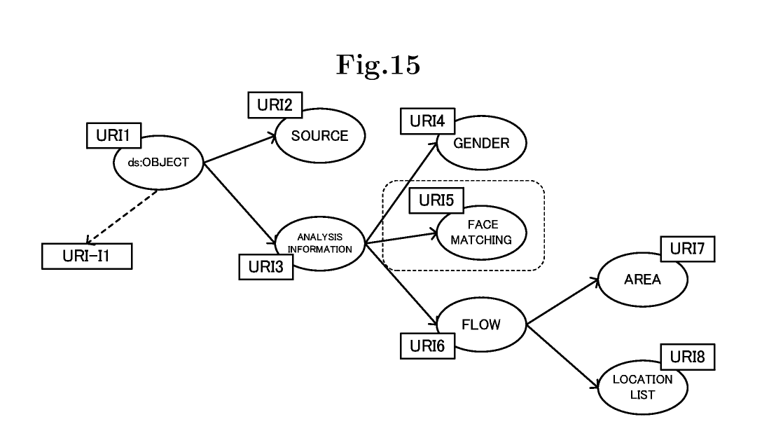

To be specific, the analysis data integrating unit 11 finds that the URI of a top node of the graph data with “URI-I3” to be added is “URI 3” as shown in FIG. 5B. Moreover, because the class of the graph data to become the integration source designated by “URI-I1” is the class “ds: object,” the analysis data integrating unit 11 finds with reference to the data schema shown in FIG. 6 that a node with an identical URI “URI 3” is the node “analysis information” of the class “ds: object.” Thus, the analysis data integrating unit 11 replaces a link connected to a node “analysis information 2” of “URI-I3” with the node “analysis information” of “URI-I1” as shown in FIG. 14 (refer to the inside of a dotted line frame and an arrow in FIG. 14). Then, as shown in a dotted line frame shown in FIG. 15, the analysis data integrating unit 11 integrates the graph data of “URI-I3” with the graph data of “URI-I1,” and registers into the analysis data storage 8. At this moment, the analysis data integrating unit 11 also registers information of “URI-I3.”

Subsequently, the event judging unit 4 judges whether there is an applicable event based on the registered graph data (step S14). At this moment, in a case that “area name” is registered in the node with “URI 7” and a value of “true” is registered into the node with “URI 5” as the result of a node “face matching” with “URI 5,” the “condition” set in the “process phase 3” shown in FIG. 9 is satisfied, so that the event judging unit 4 judges that there is a notification event of “suspect intrusion” (step S14: Yes). Therefore, the event judging unit 4 notifies to the notification application 2 that there is a notification event of “suspect intrusion” (step S15), and the notification application 2 executes a notification event of “suspect intrusion.” Because there is no more next process phase (step S16: No), the procedure ends.

Herein, a case that there is one integration data has been described above, but there may be a plurality of data. For example, in a case that it is desired to integrate data with both information of “URI 2” and information of “URI 3,” two instances “URI-I2” and “URI-I3” can be integrated as integration data in a like process.

Further, in this exemplary embodiment, the analysis data cache 13 is included in the analysis process integrating unit 1 as shown in FIG. 1, and the analysis data cache 13 may be used in the process at steps S11 to S13 shown in FIG. 11, namely, in a process of judging whether an instance URI is already registered or not. To be specific, firstly, it is set that “instance URI” having been read and written for a predetermined period is cached in the analysis data cache 13. Then, at step S11, the analysis data integrating unit 11 confirms whether there is a target instance URI in the analysis data cache 13 and, when there is not, acquires from the analysis data storage 8 and registers into the analysis data cache 13.

Consequently, the analysis data integrating unit 11 can judge whether an instance URI registered from an analysis engine has already been registered or not with reference to data in the analysis data cache 13, and it is possible to achieve increase of the speed of the analysis data integration process.

<Supplementary Notes>

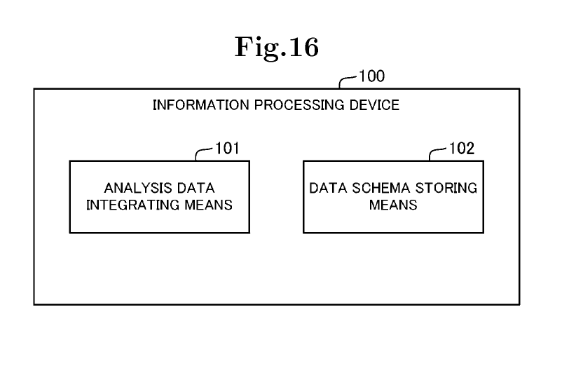

The whole or part of the exemplary embodiments disclosed above can be described as the following supplementary notes. Below, the overview of the configuration of the information processing device according to the present invention will be described with reference to FIG. 16. The present invention, however, is not limited to the following configurations.

(Supplementary Note 1)

An information processing device 100, including:

a data schema storing means 102 for storing data schemas which are set for respective analysis engines and represent data structures of graph data which are analysis results generated by the respective analysis engines and each include a plurality of connected nodes; and

an analysis data integrating means 101 for integrating the graph data that are the analysis results generated by the respective analysis engines, wherein:

in each of the data schemas stored by the data schema storing means 102, path information for referring to the respective nodes in the graph data and node identification information for identifying the respective nodes referred to by the respective path information are associated with each other; and

the analysis data integrating means 101 is configured to receive the graph data that are the analysis results from the respective analysis engines, and couple and integrate the graph data at the nodes whose node identification information are identical to each other based on the data schemas corresponding to the respective analysis engines.

(Supplementary Note 2)

The information processing device according to Supplementary Note 1, wherein the analysis data integrating means is configured to integrate one of the graph data and another one of the graph data by connecting, to a node included by the one graph data, another node which is included by the other graph data and connected to a node which is included by the other graph data and associated with information identical to the node identification information of the node included by the one graph data.

(Supplementary Note 3)

The information processing device according to Supplementary Note 2, wherein:

in the data schema, identification information of a node located in a highest hierarchy in a data structure of the other graph data and identification information of a node located in any hierarchy of the one graph data are set to be identical to each other; and

the analysis data integrating means is configured to integrate the one graph data and the other graph data by connecting a node located in a lower hierarchy than the highest hierarchy of the other graph data to below a node which is included by the one graph data and associated with identification information identical to the identification information of the node located in the highest hierarchy of the other graph data.

(Supplementary Note 4)

The information processing device according to any of Supplementary Notes 1 to 3, including an execution sequence storing means for storing an execution sequence of the analysis engines that generate the graph data to be integrated, wherein the analysis data integrating means is configured to integrate the graph data generated by the respective analysis engines executed in accordance with the execution sequence.

(Supplementary Note 5)

The information processing device according to Supplementary Note 4, wherein the analysis data integrating means is configured to: execute each of the analysis engines in accordance with the execution sequence stored by the execution sequence storing means; receive graph data generated by the analysis engine from the said analysis engine and also graph identification information unique to the graph data; give the graph identification information as graph identification information of an integration source to the analysis engine to be executed next in accordance with the execution sequence; receive graph data generated by the analysis engine executed next from the said analysis engine and also the graph identification information of the integration source; and integrate the graph data generated by the analysis engines that the received graph identification information are identical to each other.

(Supplementary Note 6)

The information processing device according to Supplementary Note 5, wherein the analysis data integrating means is configured to: receive the graph data and the graph identification information from the analysis engine; in a case that the received graph identification information is not stored in a storage device, store the received graph data and graph identification information into the storage device; and in a case that the received graph identification information is stored in the storage device, integrate the received graph data with the graph data stored in the storage device in association with the received graph identification information.

(Supplementary Note 7)

The information processing device according to any of Supplementary Notes 1 to 6, including:

an execution rule storing means for storing execution process information representing a process to be executed corresponding to information registered into the node of the graph data, in association with the node identification information for identifying the said node; and

a process executing means for, based on the information stored by the execution rule storing means, executing the process represented by the execution process information associated with the node identification information of the node in which predetermined information has been registered by the analysis data integrating means.

(Supplementary Note 8)

The information processing device according to Supplementary Note 7, wherein:

the execution rule storing means is configured to store, as a condition for executing the process represented by the execution process information, execution condition information registered into the node corresponding to the node identification information associated with the execution process information; and

the process executing means is configured to, when the execution condition information stored by the execution rule storing means is registered into the node by the analysis data integrating means, execute the process represented by the execution process information associated with the node identification information of the said node.

(Supplementary Note 9)

The information processing device according to Supplementary Note 7 or 8, including an execution sequence storing means for storing an execution sequence of the analysis engines that generate the graph data to be integrated, wherein:

the analysis data integrating means is configured to, every time each of the graph data is generated by each of the analysis engines executed in accordance with the execution sequence, execute integration of the graph data; and the process executing means is configured to operate every time the analysis data integrating means executes the integration of the graph data.

(Supplementary Note 10)

A computer program including instructions for causing an information processing device including a data schema storing means for storing data schemas which are set for respective analysis engines and represent data structures of graph data which are analysis results generated by the respective analysis engines and each include a plurality of connected nodes, to realize an analysis data integrating means for integrating the graph data that are the analysis results generated by the respective analysis engines, wherein:

in each of the data schemas stored by the data schema storing means, path information for referring to the respective nodes in the graph data and node identification information for identifying the respective nodes referred to by the respective path information are associated with each other; and

the analysis data integrating means is configured to receive the graph data that are the analysis results from the respective analysis engines, and couple and integrate the graph data at the nodes whose node identification information are identical to each other based on the data schemas corresponding to the respective analysis engines.

(Supplementary Note 11)

The computer program according to Supplementary Note 10, wherein the analysis data integrating means is configured to integrate one of the graph data and another one of the graph data by connecting, to a node included by the one graph data, another node which is included by the other graph data and connected to a node which is included by the other graph data and associated with information identical to the node identification information of the node included by the one graph data.

(Supplementary Note 12)

An information processing method by an information processing device including a data schema storing means for storing data schemas which are set for respective analysis engines and represent data structures of graph data which are analysis results generated by the respective analysis engines and each include a plurality of connected nodes, wherein in each of the data schemas stored by the data schema storing means, path information for referring to the respective nodes in the graph data and node identification information for identifying the respective nodes referred to by the respective path information are associated with each other,

the information processing method including:

in integration of the graph data that are the analysis results generated by the respective analysis engines, receiving the graph data that are the analysis results from the respective analysis engines, and coupling and integrating the graph data at the nodes whose node identification information are identical to each other based on the data schemas corresponding to the respective analysis engines.

(Supplementary Note 13)

The information processing method according to Supplementary Note 12, comprising:

in the integration of the graph data, integrating one of the graph data and another one of the graph data by connecting, to a node included by the one graph data, another node which is included by the other graph data and connected to a node which is included by the other graph data and associated with information identical to the node identification information of the node included by the one graph data.

The present invention is based upon and claims the benefit of priority from Japanese patent application No. 2010-250630, filed on Nov. 9, 2010, the disclosure of which is incorporated herein in its entirety by reference.

### DESCRIPTION OF REFERENCE NUMERALS

1 analysis process integrating unit

2 notification application

3 data schema

4 event judging unit

5 event rule

6 analysis engine

7 analysis data accumulating unit

8 analysis data storage

9 data schema registering unit

11 analysis data integrating unit

12 analysis process flow

13 analysis data cache

61 flow generation engine

72 person judgment engine

63 face matching engine

100 information processing device

101 analysis data integrating means

102 data schema storing means

What is claimed is:

1. An information processing device, comprising:
a data schema storing unit for storing data schemas which are set for respective analysis engines and represent data structures of graph data which are analysis results generated by the respective analysis engines and each include a plurality of connected nodes; and
an analysis data integrating unit for integrating the graph data that are the analysis results generated by the respective analysis engines, wherein:
in each of the data schemas stored by the data schema storing unit, path information for referring to the respective nodes in the graph data and node identification information for identifying the respective nodes referred to by the respective path information are associated with each other; and
the analysis data integrating unit is configured to receive the graph data that are the analysis results from the respective analysis engines, and couple and integrate the graph data at the nodes whose node identification information are identical to each other based on the data schemas corresponding to the respective analysis engines.

2. The information processing device according to claim 1, wherein the analysis data integrating unit is configured to integrate one of the graph data and another one of the graph data by connecting, to a node included by the one graph data, another node which is included by the other graph data and connected to a node which is included by the other graph data and associated with information identical to the node identification information of the node included by the one graph data.

3. The information processing device according to claim 2, wherein:
in the data schema, identification information of a node located in a highest hierarchy in a data structure of the other graph data and identification information of a node located in any hierarchy of the one graph data are set to be identical to each other; and
the analysis data integrating unit is configured to integrate the one graph data and the other graph data by connecting a node located in a lower hierarchy than the highest hierarchy of the other graph data to below a node which is included by the one graph data and associated with identification information identical to the identification information of the node located in the highest hierarchy of the other graph data.

4. The information processing device according to claim 1, comprising an execution sequence storing unit for storing an execution sequence of the analysis engines that generate the graph data to be integrated,
wherein the analysis data integrating unit is configured to integrate the graph data generated by the respective analysis engines executed in accordance with the execution sequence.

5. The information processing device according to claim 4, wherein the analysis data integrating unit is configured to: execute each of the analysis engines in accordance with the execution sequence stored by the execution sequence storing unit; receive graph data generated by the analysis engine from the said analysis engine and also graph identification information unique to the graph data; give the graph identification information as graph identification information of an integration source to the analysis engine to be executed next in accordance with the execution sequence; receive graph data generated by the analysis engine executed next from the said analysis engine and also the graph identification information of the integration source; and integrate the graph data generated by the analysis engines that the received graph identification information are identical to each other.

6. The information processing device according to claim 5, wherein the analysis data integrating unit is configured to: receive the graph data and the graph identification information from the analysis engine; in a case that the received graph identification information is not stored in a storage device, store the received graph data and graph identification information into the storage device; and in a case that the received graph identification information is stored in the storage device, integrate the received graph data with the graph data stored in the storage device in association with the received graph identification information.

7. The information processing device according to claim 1, comprising:
an execution rule storing unit for storing execution process information representing a process to be executed corresponding to information registered into the node of the graph data, in association with the node identification information for identifying the said node; and
a process executing unit for, based on the information stored by the execution rule storing unit, executing the process represented by the execution process information associated with the node identification information of the node in which predetermined information has been registered by the analysis data integrating unit.

8. The information processing device according to claim 7, wherein:
the execution rule storing unit is configured to store, as a condition for executing the process represented by the execution process information, execution condition information registered into the node corresponding to the node identification information associated with the execution process information; and
the process executing unit is configured to, when the execution condition information stored by the execution rule storing unit is registered into the node by the analysis data integrating unit, execute the process represented by the execution process information associated with the node identification information of the said node.

9. The information processing device according to claim 7, comprising an execution sequence storing unit for storing an execution sequence of the analysis engines that generate the graph data to be integrated, wherein:
the analysis data integrating unit is configured to, every time each of the graph data is generated by each of the analysis engines executed in accordance with the execution sequence, execute integration of the graph data; and
the process executing unit is configured to operate every time the analysis data integrating unit executes the integration of the graph data.

10. A non-transitory computer-readable medium storing a program comprising instructions for causing an information processing device including a data schema storing unit for storing data schemas which are set for respective analysis engines and represent data structures of graph data which are analysis results generated by the respective analysis engines and each include a plurality of connected nodes, to realize an analysis data integrating unit for integrating the graph data that are the analysis results generated by the respective analysis engines, wherein:
in each of the data schemas stored by the data schema storing unit, path information for referring to the respective nodes in the graph data and node identification information for identifying the respective nodes referred to by the respective path information are associated with each other; and
the analysis data integrating unit is configured to receive the graph data that are the analysis results from the respective analysis engines, and couple and integrate the graph data at the nodes whose node identification information are identical to each other based on the data schemas corresponding to the respective analysis engines.

11. The non-transitory computer-readable medium according to claim 10, wherein the analysis data integrating unit is configured to integrate one of the graph data and another one of the graph data by connecting, to a node included by the one graph data, another node which is included by the other graph data and connected to a node which is included by the other graph data and associated with information identical to the node identification information of the node included by the one graph data.

12. An information processing method by an information processing device including a data schema storing unit for storing data schemas which are set for respective analysis engines and represent data structures of graph data which are analysis results generated by the respective analysis engines and each include a plurality of connected nodes, wherein in each of the data schemas stored by the data schema storing unit, path information for referring to the respective nodes in the graph data and node identification information for identifying the respective nodes referred to by the respective path information are associated with each other,
the information processing method comprising:
in integration of the graph data that are the analysis results generated by the respective analysis engines, receiving the graph data that are the analysis results from the respective analysis engines, and coupling and integrating the graph data at the nodes whose node identification information are identical to each other based on the data schemas corresponding to the respective analysis engines.

13. The information processing method according to claim 12, comprising:
in the integration of the graph data, integrating one of the graph data and another one of the graph data by connecting, to a node included by the one graph data, another node which is included by the other graph data and connected to a node which is included by the other graph data and associated with information identical to the node identification information of the node included by the one graph data.
